(19) United States
(12) Patent Application Publication
(10) Pub. No.: US 2021/0384532 A1
(43) Pub. Date: Dec. 9, 2021

(54) HUMIDIFIER AND MOTOR VEHICLE

(71) Applicants: AUDI AG, Ingolstadt (DE); Volkswagen AG, Wolfsburg (DE)

(72) Inventor: Christian LUCAS, Braunschweig (DE)

(21) Appl. No.: 17/288,454

(22) PCT Filed: Apr. 24, 2019
(86) PCT No.: PCT/EP2019/060408

§ 371 Date: Apr. 23, 2021

(30) Foreign Application Priority Data
Oct. 26, 2018 (DE) 10 2018 218 317.1

(51) Int. Cl. H01M 8/04119; H01M 8/04007; B60L 58/33

(52) U.S. Cl. CPC H01M 8/04134; H01M 2250/20; B60L 58/33; H01M 8/04074

(57) ABSTRACT

A humidifier for a fuel cell device has a plurality of flow field frames, between each of which there is arranged a humidifier membrane. A plurality of cooling flow field frames formed identical to the flow field frames, between each of which there is arranged a separating plate, form an integrated intercooler. A motor vehicle having a humidifier with integrated intercooler is also provided.

### BACKGROUND

### Technical Field

Embodiments of the invention relate to a humidifier for a fuel cell device, having a plurality of flow field frames, between each of which there is arranged a humidifier membrane. Embodiments of the invention furthermore relate to a motor vehicle.

### Description of the Related Art

Humidifiers are generally used to bring about a transfer of moisture in the case of two gaseous media having a different moisture content to the dryer medium. Such gas/gas-humidifiers find use in particular in fuel cell device in which air with the oxygen contained therein is compressed in the cathode circuit in order to supply the cathode spaces of the fuel cell stack, so that relatively warm and dry compressed air is present whose humidity is not sufficient for use in the fuel cell stacks for the membrane electrode unit. The dry air for the fuel cell stack which is provided by the compressor is humidified by moving it past the membrane, which is permeable to water vapor, the other side of which is swept with the moist exhaust air from the fuel cell stack. For the conditioning of the air being supplied to the cathode spaces of the fuel cell stack a temperature control is also necessary, generally using for this an intercooler positioned downstream from the compressor. The humidifier and the intercooler are large components, contributing to a great increase in the design space required for a fuel cell device and curbing the efficiency of the fuel cell device, since large thermal losses are present.

In US 2015/0004504 A1 there is disclosed an integrated gas management device for a fuel cell, comprising a humidifier and a heat exchanger which is situated at a first end of the humidifier core.

### BRIEF SUMMARY

A problem which the present disclosure proposes to solve is to modify a humidifier of the kind mentioned above so that the degree of complexity of a fuel cell system can be reduced. A further problem is to provide an improved motor vehicle.

A humidifier may be characterized in that a plurality of cooling flow field frames formed identical to the flow field frames, between each of which there is arranged a separating plate, form an integrated intercooler. On the one hand, this ensures that the required design space can be significantly decreased, since the intercooler is integrated in the humidifier, i.e., it is assembled together with it. Moreover, besides increasing the degree of integration, the number of identical parts in the overall system of humidifier plus intercooler is also increased, since the cooling flow field frames of the intercooler are formed identical to the flow field frames of the humidifier, i.e., a production of identical parts becomes possible, and only afterwards will the parts be distributed among the humidifier and the intercooler, being then assigned and designated as flow field frames or cooling flow field frames.

A coupling plate may be provided between the flow field frames arranged in a stack and the cooling flow field frames arranged in a stack. The coupling plate provided between the flow field frames and the cooling flow field frames enables an optimization of the flow management in the respective components, so that even though the flow field frames and the cooling flow field frames have an identical layout, they can have different flow rates according to their purpose.

It is then advantageous for the coupling plate flow to be configured free of flow fields and having the identical cross section as the flow field frames and to comprise a continuous dry air line coupling the flow field frames and the cooling flow field frames for the dry air. The identical cross section as the flow field frames and cooling flow field frames ensures that the coupling plate can be integrated in the stack formed by these. It is not necessary to reproduce the thickness of the flow field frames in the case of the coupling plate, beyond maintaining the same cross section; the coupling plate may have a different thickness than the flow field frames, in particular an increased thickness. This is especially convenient in that the coupling plate can then comprise a side coolant port having a coolant line in order to take the coolant to the cooling flow field frames, and the coupling plate comprises a side air exit for the emergence of the moist air after passing through an air line from the flow field frames.

For the functioning of the humidifier it is necessary to arrange a seal on either side of each humidifier membrane. Identically formed seals are also arranged on either side of each separating plate, so that this increases the number of identical parts which are present and advantageous scale effects can be utilized during the production and assembly process.

It is furthermore proposed that the separating plate is formed of a metal or a metal alloy in order to ensure a reliable separation of the flows in the cooling flow field frames with a good heat exchange.

It is also proposed that surface enlarging elements are arranged between the separating plates in the cooling flow field frames for an improved heat transfer, being selected from a group comprising baffle plates and porous fleece.

It is furthermore proposed that shaped or porous regions are provided in the flow field frames and the cooling flow field frames for the flow field duct.

This humidifier with integrated intercooler thus has a modified layout with a large number of identical parts and it is easily possible in particular to use a different number of modules in order to adapt it to the required performance of the humidifier and/or intercooler, the number of flow field frames used being chosen independently of the number of cooling flow field frames in accordance with the needs.

Hence, it is also possible to improve a motor vehicle having a fuel cell device formed with a humidifier of the aforementioned kind, since the design space required for the humidifier with integrated intercooler is decreased and thus design space is freed up in the motor vehicle for further use, and moreover the costs of the motor vehicle are lower, while its efficiency is increased.

### BRIEF DESCRIPTION OF THE SEVERAL VIEWS OF THE DRAWINGS

Further benefits, features and details are provided in the following description and in the drawings.

FIG. 1 illustrates a top view of a flow field frame having ducts.

FIG. 2 illustrates a schematic representation of a side view of two flow field frames situated between humidifier membranes, where the flow field frame shown hatched carries the moist (exhaust) air and the other flow field frame shown non-hatched carries the dry (intake) air being humidified.

FIG. 3 illustrates a fuel cell stack with the auxiliary systems on the cathode side.

FIG. 4 illustrates a representation of a cooling flow field frame corresponding to FIG. 1, wherein the cooling flow field frame shown hatched carries the dry (intake) air being cooled, and the other cooling flow field frame shown non-hatched carries the coolant.

FIG. 5 illustrates a representation corresponding to FIG. 2 of two cooling flow field frames received between separating plates.

FIG. 6 illustrates a schematic representation of the flow in a humidifier with integrated intercooler, where a coupling plate is arranged between the humidifier and the intercooler.

FIG. 7 illustrates a schematic representation of the conduits and flow relations in an intercooler, corresponding to the left portion of FIG. 6.

FIG. 8 illustrates a schematic representation of the conduits and flow relations in a coupling plate, corresponding to the middle portion in FIG. 6.

FIG. 9 illustrates a schematic representation of the conduits and flow relations in a humidifier, corresponding to the right portion of FIG. 6.

FIG. 10 illustrates a representation of a flow field frame or a cooling flow field frame with a porous flow field, corresponding to FIG. 1.

FIG. 11 illustrates a schematic representation of a fleece received between two separating plates and two cooling flow field frames prior to assembly.

FIG. 12 illustrates a representation corresponding to FIG. 11 after assembly.

### DETAILED DESCRIPTION

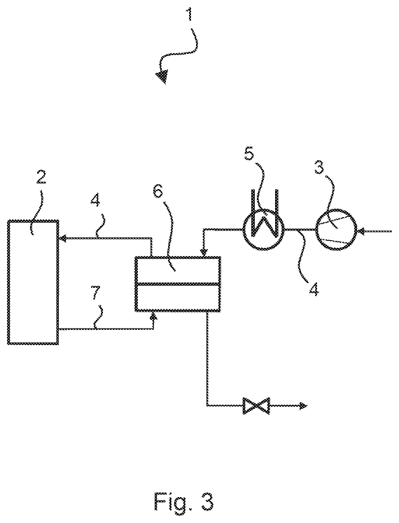

In FIG. 3 there is shown a portion of a fuel cell device 1 known in the prior art, where the fuel cell device 1 has a device for regulating the humidity of a plurality of fuel cells assembled into a fuel cell stack 2.

Fuel cells are used to provide electrical energy in a chemical reaction between a fuel, generally hydrogen, and an oxygen-containing oxidizing agent, generally air. Insofar as the power demand is greater than the power furnished by the fuel cell, the possibility exists of hooking up multiple fuel cells in series to form a fuel cell stack 2, although this increases the demand on the reactants taking part in the chemical reaction and there is a need on the cathode side to compress the cathode gas in a compressor 3. Due to this compression, greatly heated dry cathode gas is present in the cathode feed line 4 after the compressing, which is not suitable for immediate use in the fuel cell stack 2, because a sufficient humidity is required for the proton exchange membrane present in the fuel cell. Therefore, an intercooler 5 is situated in the cathode feed line 4 downstream from the compressor 3 and a humidifier 6 is situated in turn downstream from this, in which the cathode gas is moistened by taking the product water accruing during the chemical reaction through a cathode exhaust gas line 7 to the humidifier 6.

Contrary to the separate providing of a humidifier 6 and an intercooler 5 as is known in the prior art and shown in FIG. 3, systems described herein have a humidifier 6 with integrated intercooler 5, the layout of which shall be explained more closely in the following.

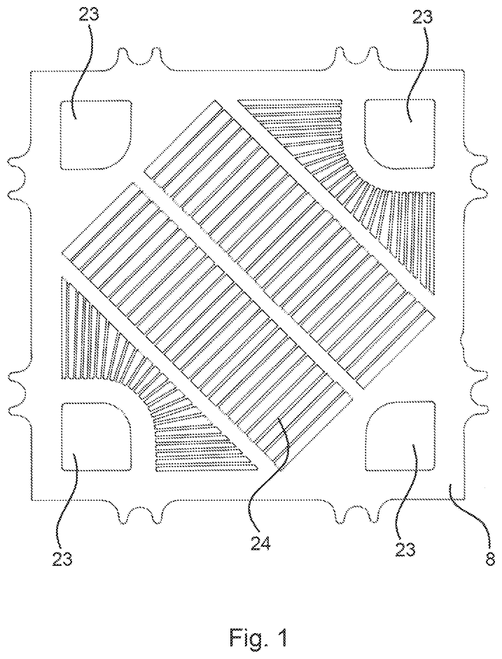

The humidifier 6 comprises a plurality of flow field frames 8, the layout of which is shown merely as an example in FIG. 1, while between each of the flow field frames 8 there is arranged a humidifier membrane 9. The humidifier 6 has a modular layout, so that a different number of flow field frames 8 can be used for a suitable design of the performance capability of the humidifier 6.

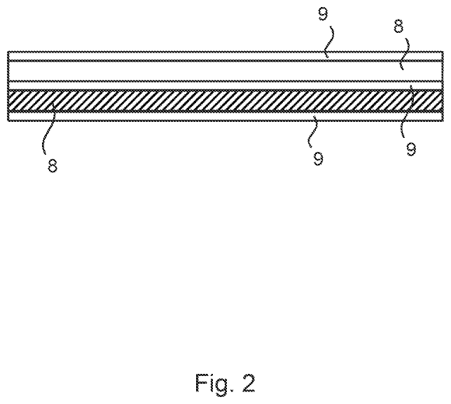

FIG. 2 shows schematically two adjacent flow field frames 8 with the associated humidifier membranes 9; it is pointed out that the flow field frames 8 in such a stack need not have the same orientation, but instead when the flow field frames 8 are assembled in pairs the one can be rotated relative to the other by 90 degrees about the axis which stands perpendicular to the surface of the flow field frame 8.

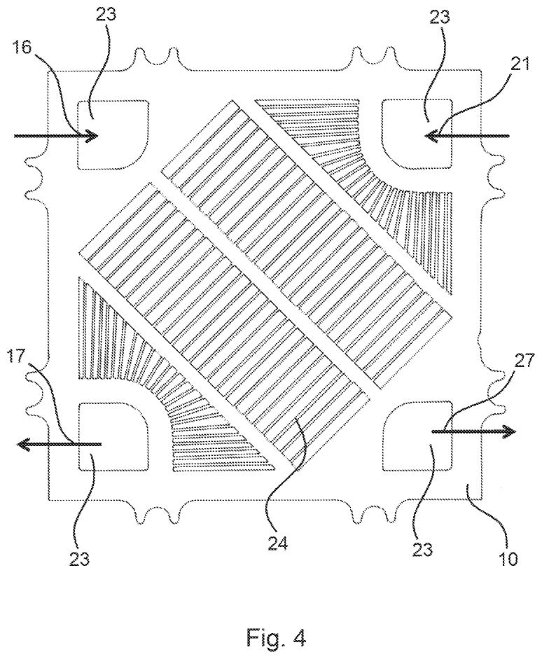

FIG. 4 shows a cooling flow field frame 10, such as is used in the intercooler 5. It is pointed out that the cooling flow field frame 10 is formed identical to the flow field frame 8 shown in FIG. 1 and represents an identical part, coming from the same production process as that for the flow field frame 8, and the different designations are due solely to the different purpose of use in the humidifier 6 on the one hand and the intercooler 5 on the other hand. FIG. 4 also clearly shows the positioning rotated by 90 degrees relative to FIG. 1; the alternating orientation may also be present for the cooling flow field frame 10.

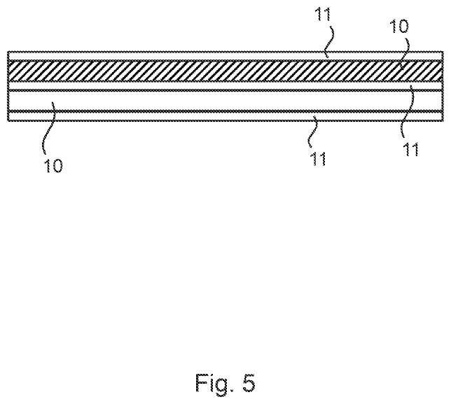

FIG. 5 shows two cooling flow field frames 10, between which there is arranged a separating plate 11, where for example dry air flows in the flow field formed by the lower cooling flow field frame 10 and the coolant flows in the upper one. A modular layout also exists in regard to the intercooler 5, and there is the possibility of installing a number of cooling flow field frames 10 with associated separating plates 11 in a stack as dictated by the desired performance capability of the intercooler 5.

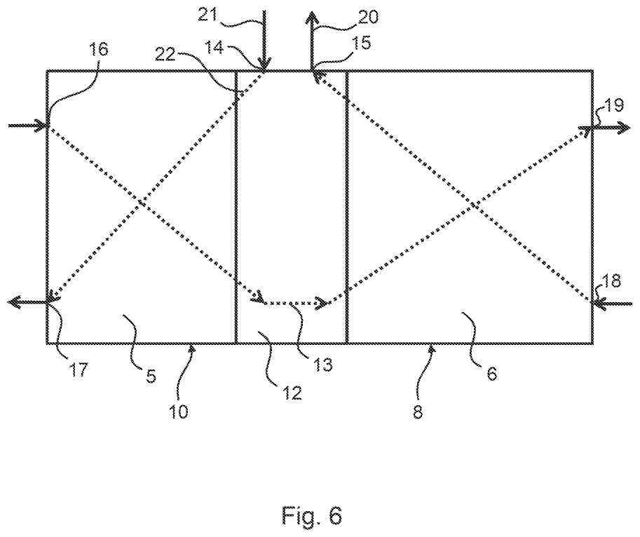

FIG. 6 explains schematically the flow relations in the humidifier 6 with integrated intercooler 5, there being arranged a coupling plate 12 between the block forming the intercooler 5 and the block forming the humidifier 6, which is itself free of flow fields and is configured with the identical cross section as the flow field frames 8 and a continuous dry air line 13 coupling the flow field frames 8 and the cooling flow field frames 10 for the dry air. The coupling plate 12 furthermore has a side coolant port 14 with a coolant line 22 for taking the coolant to the cooling flow field frames 10 and a side air exit 15 for the emergence of the moist air after moving through an air line from the flow field frames 8.

The flow relations in the humidifier 6 with integrated intercooler 5 per FIG. 6 shall be explained starting with the upper left corner and moving counterclockwise: the entrance of dry air 16 in the intercooler 5, which is taken according to the arrow to the coupling plate 12 and through this into the humidifier 6; emergence of the coolant 17; in the lower right corner, entrance of the moist air 18 in the humidifier 6, leaving the humidifier 6 in the direction of the coupling plate 12 and from there emerging through the side air exit 15; upper right, the emergence of humidified air 19 after it has passed through the intercooler 5, the coupling plate 12 and the humidifier 6; emergence of the moist (exhaust) air 20 and finally the entrance of the coolant 21 in the coupling plate 12 for routing in a coolant line 22 to the intercooler 5.

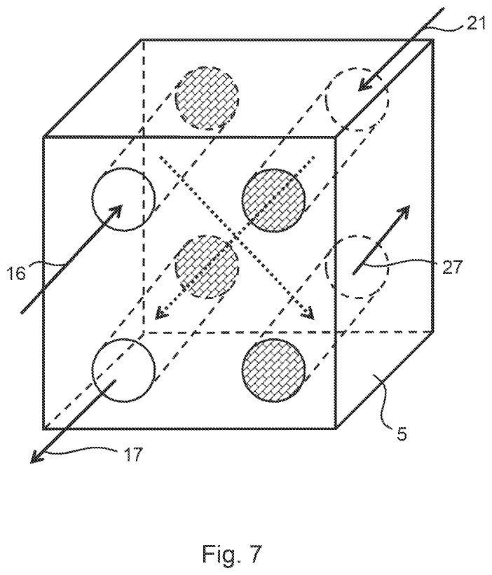

The flow relations in the intercooler 5 are also explained schematically in the cube represented in FIG. 7, where the ducts shown are each open at one end and closed at the opposite end. The entrance of the dry air occurs at 16, and it is taken through the intercooler 5 in a cross flow to the exit at 27. The entrance of the coolant is at 21, and it leaves the intercooler 5 once again at 17.

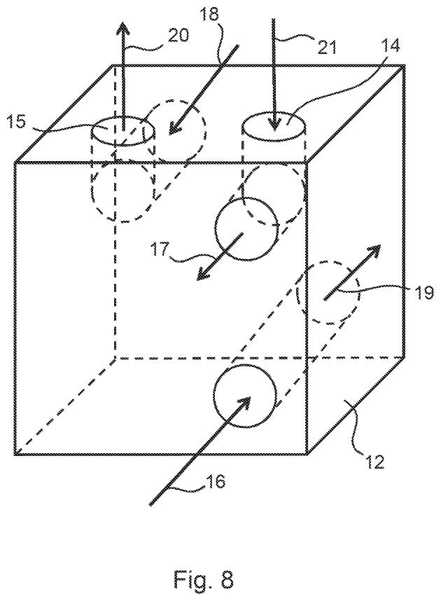

FIG. 8 shows, in a representation corresponding to FIG. 7, a cube for explaining the flow relations in the coupling plate 12. The dry air coming from the intercooler 5 enters the coupling plate 12 at 16, the dry air flows through this and leaves the coupling plate 12 once again at the opposite end, entering the humidifier 6. Above the dry air line 13 for the dry air is the entrance of the coolant 21 at 21, being taken out from the coupling plate 12 via the side coolant port 14.

The moist air from the humidifier 6 enters the coupling plate 12 at 18 and can leave it once more through the side air exit 15.

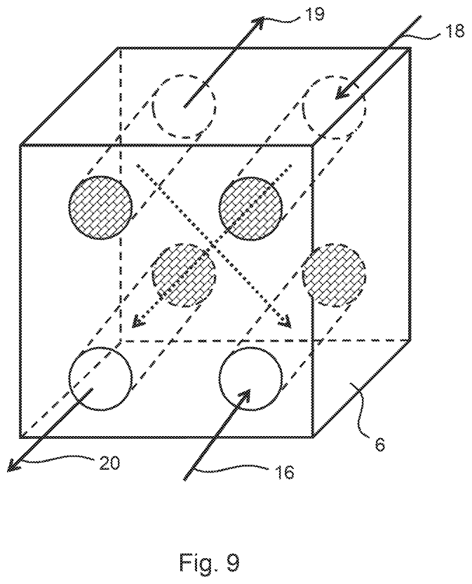

FIG. 9 is a representation corresponding to FIGS. 7 and 8 for explaining the flow relations in the humidifier 6, once again showing flow ducts which are closed at one end. At upper right, moist air 18 enters and is taken in a cross flow downward to the left 20, where it can once again leave the humidifier 6. Dry air enters at upper right 16 to be taken likewise in a cross flow upward and to the left 19, where it can then exit the cube at the rear surface.

It is pointed out that the corresponding flow ducts in the humidifier 6 and the intercooler 5 correspond to the corners 23 in the flow field frames 8 and cooling flow field frames 10, from which the flowing media are distributed into the ducts 24 of the flow fields.

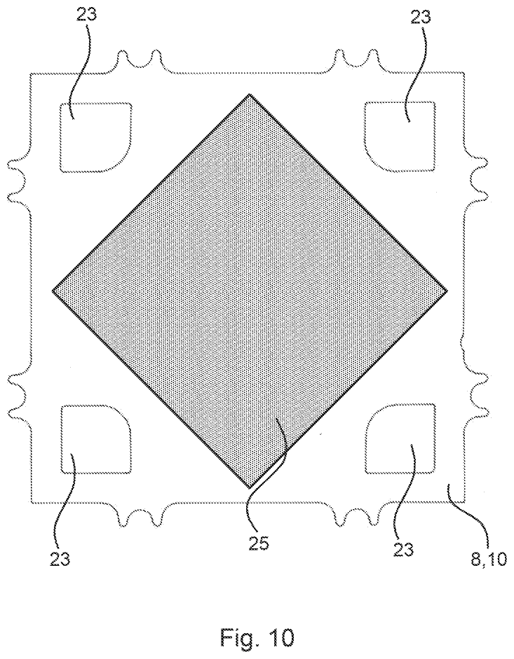

FIG. 10 shows a flow field frame 8 and a cooling flow field frame 10, where no ducts 24 are formed, but rather a porous flow field 25 is provided. The above explained flow relations remain the same here. Such a flow field frame 8 with a porous flow field 25 affords the possibility of decreasing the porosity in the intercooler 6, so that a larger surface is available for the heat transfer. Alternatively, the porosity in the humidifier region can also be enlarged in order to reduce the pressure loss in the coolant, if the associated benefits justify a reduction in the identical parts.

It should furthermore be noted that seals not represented in the drawing itself are situated on both sides of each humidifier membrane 9, and identically formed seals are also arranged on both sides of each separating plate 11, i.e., the identical parts are also present in regard to the seals.

The separating plates 11 arranged between the cooling flow field frames 10 consist of a metal or a metal alloy.

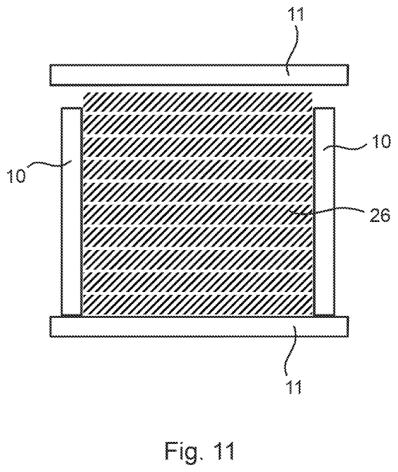

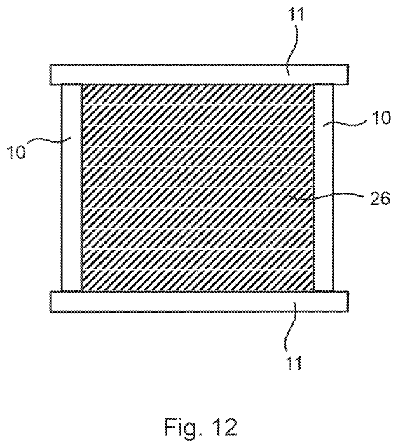

FIGS. 11 and 12 show that porous fleece 26 can also be provided for an improved heat transfer between the separating plates 11 in the cooling flow field frames 10, being press fitted during the assembly process in order to improve the contact surface for the heat transport.

In general, in the following claims, the terms used should not be construed to limit the claims to the specific embodiments disclosed in the specification and the claims, but should be construed to include all possible embodiments along with the full scope of equivalents to which such claims are entitled.

1. A humidifier for a fuel cell device, comprising:
a plurality of humidifying flow field frames, between each of which there is arranged a humidifier membrane; and
a plurality of cooling flow field frames formed identically to the humidifying flow field frames, between each of which there is arranged a separating plate, wherein the cooling flow field frames form an integrated intercooler.

2. The humidifier according to claim 1, wherein the humidifying flow field frames are arranged in a first stack, the cooling flow field frames are arranged in a second stack, and a coupling plate is provided between the first stack and the second stack.

3. The humidifier according to claim 2, wherein the coupling plate free of flow fields and has a cross section identical to that of the humidifying flow field frames, wherein the coupling plate comprises a continuous dry air line coupling the humidifying flow field frames to the cooling flow field frames.

4. The humidifier according to claim 3, wherein the coupling plate comprises a side coolant port having a coolant line in order to take coolant to the cooling flow field frames.

5. The humidifier according to claim 2, wherein the coupling plate comprises a side air exit for the emergence of moist air after passing through an air line from the humidifying flow field frames.

6. The humidifier according to claim 1, wherein a seal is arranged on either side of each humidifier membrane, and identically formed seals are arranged on either side of each separating plate.

7. The humidifier according to claim 1, wherein the separating plate is formed of a metal or a metal alloy.

8. The humidifier according to claim 1, wherein surface enlarging elements are arranged between the separating plates in the cooling flow field frames for an improved heat transfer, being selected from a group comprising baffle plates and porous fleece.

9. The humidifier according to claim 1, wherein shaped or porous flow fields are provided in the humidifying flow field frames and the cooling flow field frames for a flow field duct.

10. A motor vehicle having a fuel cell device comprising a humidifier that comprises:
a plurality of humidifying flow field frames, between each of which there is arranged a humidifier membrane; and
a plurality of cooling flow field frames formed identically to the humidifying flow field frames, between each of which there is arranged a separating plate, wherein the cooling flow field frames form an integrated intercooler.
